(19) United States
(12) Patent Application Publication
(10) Pub. No.: US 2026/0126164 A1
(43) Pub. Date: May 7, 2026

(54) LIGHT FIXTURE

(71) Applicant: ERCO GmbH, Lüdenscheid (DE)

(72) Inventor: Matthias BREMERICH, Lennestadt (DE)

(21) Appl. No.: 19/320,332

(22) Filed: Sep. 5, 2025

(30) Foreign Application Priority Data
Sep. 12, 2024 (DE) 10 2024 126 257.5

(51) Int. Cl. F21V 7/00; F21S 8/00; F21Y 113/00; F21Y 115/10

(52) U.S. Cl. CPC F21V 7/0008; F21S 8/033; F21Y 2113/00; F21Y 2115/10

(57) ABSTRACT

A luminaire to be mounted into a first building wall and for illuminating a second building wall arranged adjacently to the first building wall, including a housing, a printed circuit board on which a plurality of LED clusters are arranged, and a reflector arrangement having a number of reflector bowls that corresponds to the number of the LED clusters. The housing is recessed, with the reflector arrangement, into the first building wall. The reflector arrangement protrudes outwards from the first building wall with a protruding portion. The luminaire is covered by a dome-shaped cover that has a transparent cutout that faces the second building wall in the assembly state of the luminaire and which allows the light components, emitted from the LED clusters and reflected at the reflector bowls, including light components reflected at the protruding portion, to pass through to the second building wall.

The invention relates to a luminaire according to claim 1.

The applicant has been developing and manufacturing luminaires for illuminating building surfaces for more than eight decades.

The present patent application relates to a luminaire which is fitted into a first building wall and serves for illuminating a second building wall. For example, the luminaire can be configured as a ground recessed luminaire and serve for illuminating a vertical or substantially vertical second building wall that is adjacent to the base wall.

The luminaire according to the invention is intended to illuminate the surface provided by the second building wall as homogeneously as possible. If the second building wall is a vertical wall, both deep regions of the second building wall and high regions are intended to be illuminated homogeneously. Furthermore, it is desirable for the luminaire to manage with only a very small wall clearance and to nonetheless homogeneously illuminate very wide regions of the second building wall.

The object of the invention is that of developing a luminaire which, as a recessed luminaire, is suitable for homogeneously illuminating high and wide building surfaces and which allows an only small wall clearance.

The invention achieves this object with the features of claim 1.

The luminaire according to the invention serves to be fitted into a first building wall and to illuminate a second building wall. The second building wall in particular adjoins the first building wall. For example, the first building wall may be a base wall, and the second building wall a vertical or substantially vertical building wall.

The luminaire can be arranged at an only small wall clearance from the second building wall, for example at a clearance of 50 cm or 80 cm from the second building wall. When such small wall clearances are used, e.g. wall heights of up to approximately 5 m in height can be illuminated homogeneously.

For the event that even higher walls, of e.g. 8 m to 10 m in height, are to be flooded homogeneously, the luminaires according to the invention can have wall clearances of e.g. 100 cm to 150 cm. These small wall clearances cannot be achieved with luminaires of the prior art.

The luminaire according to the invention comprises a housing which is configured e.g. as an installation housing and is for example cast into a base wall or mounted in a cavity provided there. A printed circuit board is arranged within the housing, on which board a plurality of LED clusters are arranged.

An LED cluster within the meaning of the invention is a compact arrangement of one or more LEDs which provide a light point or a type of light point. The LEDs are thus not arranged in large number on a printed circuit board and arranged widely distributed along the printed circuit board surface, but rather an LED cluster is a centered, light-emitting region in the manner of a light point. An LED cluster can comprise e.g. two high-power LEDs. An LED cluster within the meaning of the invention provides a virtually punctiform or approximately punctiform light source.

Electronic or electrical components for power supply of the LED clusters can be provided within the housing of the luminaire, e.g. control elements, controllers, drivers, and all other typically components that are required or suitable for operating an LED luminaire.

The luminaire according to the invention comprises a particular reflector arrangement: The reflector arrangement of the luminaire according to the invention comprises a plurality of reflector bowls, wherein the number of reflector bowls corresponds to the number of LED clusters. For example, the reflector arrangement according to the invention can comprise two or three reflector bowls and correspondingly two or three LED clusters. Each LED cluster is associated with its own reflector bowl. Each reflector bowl is associated with its own LED cluster.

The reflector bowls each comprise a highly reflective freeform surface, which is designed and optimized using algorithms. The interior of each reflector bowl faces the respective LED cluster. The printed circuit board comprising the LED clusters is arranged between the second building wall and the reflector arrangement with the reflector bowls, in the mounted state of the luminaire. Each reflector bowl receives light only from one LED cluster, and each LED cluster radiates light only or largely only into one of the reflector bowls.

One embodiment of the invention comprises three LED clusters and three reflector bowls. Each LED cluster comprises a plurality of LEDs, e.g. two high-power LEDs. The plurality of reflector bowls can be interconnected, in particular combined integrally to form a reflector arrangement. The inner surfaces of the reflector bowls are in particular highly mirrored.

The reflector arrangement can e.g. be provided by a plastics injection-molded part, which is provided with a highly reflective coating in the region of the reflector bowls.

The luminaire comprises an installation housing, which is recessed into the first building wall, in particular recessed fully or largely fully into the first building wall.

The reflector arrangement protrudes at least in part, with a protruding portion, out of the first building wall, towards the outside. For example, the protruding portion can amount to approximately one fifth or approximately one third of the longitudinal extension of the reflector bowl, optionally also half the extension of the reflector bowl. This allows for illumination even of those regions of the second building wall that are directly adjacent to the luminaire. In the case of a luminaire according to the invention configured as a ground recessed luminaire, which serves for illuminating a vertical building wall, light components that are reflected at the protruding portion of the reflector bowl, which protrudes out of the first building wall, are cast onto the lower regions of the vertically oriented second building wall, i.e. onto the wall regions that are directly adjacent to the first building wall. Thus, the second building wall can be illuminated all the way to the very bottom, i.e. even to close to the ground surface.

The luminaire according to the invention furthermore comprises a cover, which is configured to be curved, e.g. curved in a dome-shaped manner. The cover protects the luminaire, recessed into the first building wall, and the protruding portion, from damage and other impairments. The cover also protrudes from the first building wall.

The cover is configured to be optically opaque. It comprises a cutout which is configured to be transparent, i.e. a type of window. This window allows for light emission.

The cutout can be configured as an opening in the cover, or can comprise a transparent pane, e.g. a glass pane or a plastics pane.

The cutout in the cover faces the second building wall in the assembly state of the luminaire. It can for example make up a region of approximately one fifth or one tenth of the total surface area of the cover.

In contrast to conventional recessed wall luminaires, the luminaire according to the invention is not formed completely flush with the first building wall, but rather protrudes therefrom at least with a protruding portion of the reflector arrangement. Thus, lower regions of the second building wall, which is to be illuminated vertically, can also be illuminated.

The light components which, proceeding from an LED cluster, strike the protruding portion and are reflected there are deflected to those regions of the second building wall that are directly adjacent to the luminaire. Thus, these adjacent regions of the second building wall can also be illuminated homogeneously.

The protruding portion comprises in particular portions of all the reflector bowls. Each of the plurality of reflector bowls thus protrudes, with a region, out of the first building wall, and thus contributes to the protruding portion.

According to the invention, the reflector arrangement comprises a plurality of reflector bowls. This makes it possible to provide different light distributions, which originate from different reflector bowls, wherein the light distributions can overlap one another at least in part. Precisely due to this overlapping, a very homogeneous illumination of the second building wall can be achieved.

Since a plurality of LED clusters are arranged distributed on the printed circuit board, and since a plurality of reflector bowls are provided, wherein in each case one reflector bowl is associated with one LED cluster, a homogenization of the radiant power on the LED printed circuit board can be achieved, and the multiple overlap of light distributions on the first building wall, which light distributions originate from different reflector bowls, can be achieved in the first place. In addition to optimized technology, the cooling of the LEDs on the printed circuit board is also simplified since the plurality of LED clusters are arranged spaced apart from one another.

The luminaire according to the invention offers the possibility of providing an intersecting light beam characteristic, in particular a light beam characteristic that intersects in multiple respects, by a corresponding design of the reflector surfaces and the reflector bowls.

It can thus be provided, for example when considering a single reflector bowl, that light beams which, proceeding from an LED cluster, are radiated down to a lower bowl edge of the reflector bowl, close to the LED cluster, and are reflected there in such a way that they are cast onto extremely remote regions of the second building wall. Those light components which, proceeding from an LED cluster, are emitted towards an upper bowl edge of the reflector bowl, remote from the LED cluster, are reflected there at the protruding portion in such a way that they are cast towards a region of the second building surface that is arranged close to the luminaire.

Furthermore, light components which, proceeding from an LED cluster, are first cast to a first, left-hand or front, side of the reflector bowl, can be reflected in such a way that they are cast towards a rear wall portion of the second building wall that is arranged on the right-hand side. Light components which, proceeding from an LED cluster, are emitted towards rear portions of the reflector bowl arranged on the right-hand side are deflected, after reflection, towards a left-hand, front portion of the second building wall. This cross-over characteristic can also be referred to as a direction change in a double sense.

This direction change in a double sense contributes to a homogeneous illumination of the second building wall.

The luminaire according to the invention offers the possibility of such a direction change or a cross-over reflection not only with respect to a single LED cluster but rather in particular also based on the entirety of the reflector bowls.

Thus, in the case of a luminaire according to the invention that comprises just two reflector bowls, the right-hand, rear reflector bowl of the two reflector bowls of an embodiment of the luminaire according to the invention can primarily illuminate left-hand, front wall regions of the second building wall, and the left-hand, front reflector bowl can primarily illuminate right-hand, rear wall regions of the second building wall. In this way, too, an overlapping of light distributions is achieved according to the invention.

If an embodiment of the luminaire according to the invention comprises a reflector arrangement comprising three reflector bowls, three light distributions that overlap one another at least in part can be achieved. This enables a particularly high degree of uniformity and homogeneity of the illumination of the second building wall.

According to an advantageous embodiment of the invention, the reflector bowls each comprise an upper or outer bowl edge, protruding from the first building wall, and an inner, lower bowl edge, which is arranged inside the first building wall. This embodiment of the invention allows for the luminaire to be fitted into the first building wall in such a way that the outer, upper bowl edge of each reflector bowl protrudes outwards beyond the first building wall. The protruding portion of the reflector arrangement thus also allows for illumination of portions of the second building wall which are arranged very close to the luminaire.

According to an advantageous embodiment of the invention, an imaginary connection line between an outer bowl edge and an inner bowl edge forms a straight line which is arranged inclined to the second building wall. This embodiment of the invention allows for a particularly compact luminaire.

Advantageously, each reflector bowl comprises an outer, upper bowl edge and an inner, lower bowl edge. Further advantageously, a straight connection line can be laid between the inner, lower bowl edge of each reflector bowl and the outer, upper bowl edge of the same reflector bowl, wherein this plurality of straight connection lines of the different reflector bowls are arranged in parallel with one another.

The invention also covers the case where each reflector bowl is surrounded by a marginal edge, which provides a contour that is configured to be substantially leaf-shaped or drop-shaped.

The contour of a reflector bowl can in particular be configured to taper in its upper region.

According to an advantageous embodiment of the invention, the LED clusters of one reflector bowl are arranged closer to the inner bowl edge of said reflector bowl than to the outer bowl edge of said reflector bowl. This embodiment of the invention makes it possible to achieve an optimal light distribution and an advantageous construction of the respective reflector bowls.

According to an advantageous embodiment of the invention, the outer, upper bowl edge of a reflector bowl, in particular the outer, upper bowl edge of each reflector bowl, is spaced approximately 1.5 times to 10 times as far from the associated LED cluster compared with the inner, lower bowl edge of the reflector bowl. This embodiment of the invention allows for a particularly efficient light guidance of the light emitted by an LED cluster, as a result of a reflection at the reflector bowl.

According to an advantageous embodiment of the invention, the plurality of LED clusters are arranged along a straight line which extends in parallel with the second building wall. This embodiment of the invention allows for a particularly compact design of a luminaire according to the invention.

According to an advantageous embodiment of the invention, each reflector bowl, based on the direction of the straight line, has a front bowl edge and a rear bowl edge, wherein the second building wall, based on the direction of the straight line, has a front wall region and a rear wall region, wherein the light components that are cast from an LED cluster onto portions of the associated reflector bowl which are arranged close to the front bowl edge are deflected towards regions of the second building wall that are adjacent to the rear wall region, and wherein the light components that are cast from an LED cluster onto portions of the associated reflector bowl that are arranged close to the rear bowl edge are deflected towards regions of the second building wall that are adjacent to the front wall region. This embodiment of the invention allows for a particularly homogeneous illumination of the second building wall.

According to an advantageous embodiment of the invention, only those light components, emitted by the LED clusters, that have undergone a reflection at a reflector bowl of the reflector arrangement strike the second building surface. This embodiment of the invention allows for optimized light guidance and the provision of a luminaire according to the invention that is configured to be glare-free.

According to an advantageous embodiment of the invention, shielding elements are arranged on the luminaire. This embodiment of the invention allows e.g. for the arrangement of a first shielding element directly adjacently to an LED cluster, which prevents light emission of unreflected light from the luminaire. Such direct light components can be absorbed with the shielding element. In particular, a shielding element of this kind is positioned such that in each case one LED cluster is arranged between the shielding element and a plane defined by the first building wall.

A second shielding element can be provided according to the invention in order to prevent light components, which are reflected at the reflector bowl and are not directed immediately to the second building wall to be illuminated, from being emitted from the luminaire.

Said second shielding element also makes it possible to prevent unintended stray light components from being emitted from the luminaire.

According to an advantageous embodiment of the invention, each LED cluster is associated with a reflector bowl. This embodiment of the invention allows for an optimized construction of a luminaire according to the invention.

According to an advantageous embodiment of the invention, each reflector bowl receives light from just one LED cluster. This embodiment of the invention allows for an optimized construction of the luminaire. According to an advantageous embodiment of the invention, light components which are cast from an LED cluster onto portions of the associated reflector bowl that are arranged close to the outer, upper bowl edge are deflected towards regions of the second building wall that are adjacent to the first building wall. Furthermore, the light components which are cast from an LED cluster onto portions of the associated reflector bowl that are arranged close to the inner, lower bowl edge are deflected towards regions of the second building wall that are arranged remotely from the first building wall. This embodiment of the invention allows for a homogeneous illumination of the second building wall.

According to an advantageous embodiment of the invention, each LED cluster comprises one LED or a plurality of LEDs that are adjacent to one another or are arranged directly adjacently to one another. This embodiment of the invention allows for a particularly strong and highly efficient luminaire.

According to an advantageous embodiment of the invention, the luminaire comprises three LED clusters and three reflector bowls. This embodiment of the invention allows for a particularly optimized construction.

According to an advantageous embodiment of the invention, the luminaire is configured as a ground recessed luminaire and for illuminating a vertical or substantially vertical building wall. This embodiment of the invention allows for a particularly optimized recessed luminaire.

According to a further advantageous embodiment of the invention, at least one LED cluster of the plurality of LED clusters is composed of at least two different LEDs that emit different light spectra. These may for example be two LEDs that emit differently colored white light, such as white light of different color temperatures.

In particular the color temperature of the white light can be set between the two LEDs by relative dimming of the two LEDs. In the case of the applicant, reference is made, in the case of such actuation, to “tunable white light”.

In this case, the particular arrangement, according to the invention, of a reflector element comprising a plurality of reflector bowls, wherein the number of the reflector bowls corresponds to the number of the LED clusters, allows for homogenization and color mixing of the light emitted by the two different LEDs. Therefore, the color differences of the different light spectra can no longer be resolved on the building surface to be illuminated. The multiple overlapping of the light distributions generated by the individual reflector bowls, on the second building wall, achieves particularly good color mixing of the building surface to be illuminated.

According to a further advantageous embodiment of the invention, the two LEDs radiate light into a light guide which is fixed relative to the printed circuit board and which guides the light to a light emission surface, from which the mixed light is cast onto the associated reflector bowl. In turn, this embodiment comprises a plurality of LED clusters and corresponding plurality of light guides. Each LED cluster is associated with a light guide. The light guide can for example be provided by a fiber optic cable. The light guide guides the light further, on account of total internal reflection, and can bring about light mixing. It guides the light from the two LEDs to one light emission surface. This embodiment thus comprises a plurality of light emission surfaces of different light guides, which correspond to the number of reflector bowls. From the light emission surface of the respective light guide, the light is radiated into the associated reflector bowl.

In this embodiment, an LED cluster can also comprise three or more LEDs.

In addition to different white LEDs of different color temperatures, for example differently colored LEDs, e.g. red LEDs, green LEDs or blue LEDs, can also be used, the light components of which can be supplied to the associate reflector bowl in a manner pre-mixed particularly well, by means of the light guide.

The invention furthermore relates to a system for in particular homogeneous wall flooding according to claim 19.

This system comprises a plurality of luminaires according to the invention.

Accoding to claim 19, a plurality of luminaires are combined to form a system.

Advantageously, the luminaires can each have a first clearance from the second building wall and a second clearance from an adjacently arranged luminaire. According to the invention, the ratio of the first clearance to the second clearance can be selected to be very small, and can e.g. be between 1:5 and 1:8. This allows, according to the invention, for a homogeneous illumination of the entire second building wall, while providing an only small number of luminaires at a very small clearance of the luminaires from the wall.

The invention furthermore relates to a luminaire according to claim 22.

In turn, the object of the invention is that of providing a luminaire which allows for a small wall clearance and a large luminaire clearance and achieves an at least largely homogeneous illumination of a building wall, with a compact design.

The invention achieves this object with the features of claim 22.

The principle of the invention can be best understood in consideration of the statements regarding claims 1-21.

In contrast to the luminaire according to claim 1, the particularity of the luminaire according to claim 22 is that the reflector arrangement does not comprise any overhang region.

The luminaire according to claim 22 allows for flush fitting in the wall. The luminaire according to claim 22 can clearly no longer also illuminate those regions of the wall to be illuminated that are arranged very close to the luminaire. However, this is tolerable in some cases and use situations.

Nonetheless, the luminaire according to claim 22 also benefits from the particular arrangement of a plurality of reflector bowls and a plurality of LED clusters which, based on the overall width of the building surface, allow for homogeneous illumination of the building surface. Furthermore, the luminaire according to claim 22 takes account of the fact that, in some installation situations, an overhang out of the first building wall is not tolerable.

Otherwise, in order to avoid repetitions with regard to this invention and with regard to the embodiment according to claims 23-40, reference is made to the above statements regarding claims 1 to 21 which, as far as the understanding of the features and the appreciation of the invention according to claims 1 to 21 are concerned, apply analogously.

Further advantages of the invention emerge from the dependent claims (not cited) and on the basis of the following description of the embodiments shown in the drawings, in which:

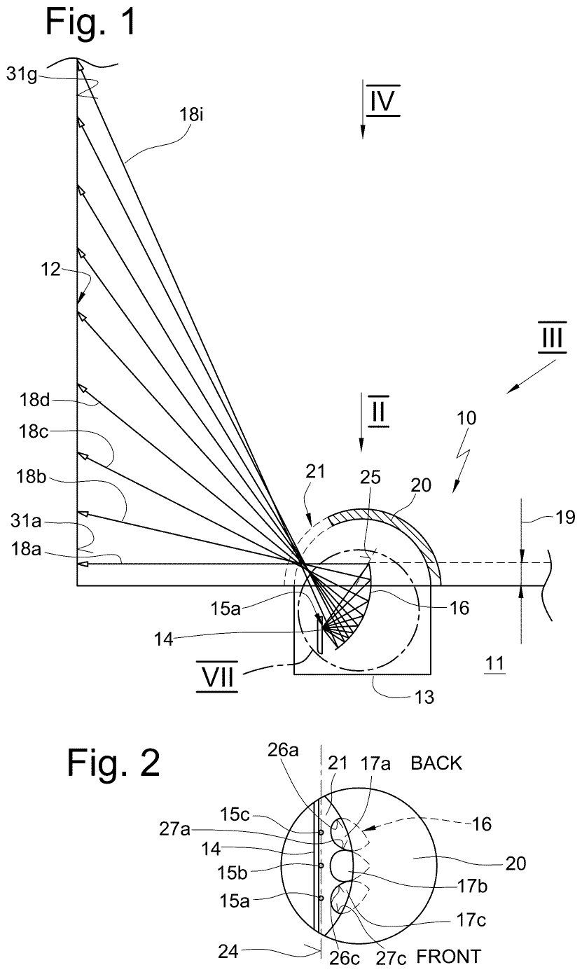

FIG. 1 is a partially sectional, schematic view of an embodiment of a luminaire according to the invention, which is configured as a ground recessed luminaire and is recessed into a first building wall, and a second, vertically oriented building wall to be illuminated, the light beam course being indicated by way of example,

FIG. 2 is a partially sectional, schematic view of the luminaire of FIG. 1, in isolation and in plan view, approximately according to the viewing arrow II in FIG. 1, showing a dome-shaped cover element that comprises a transparent cutout,

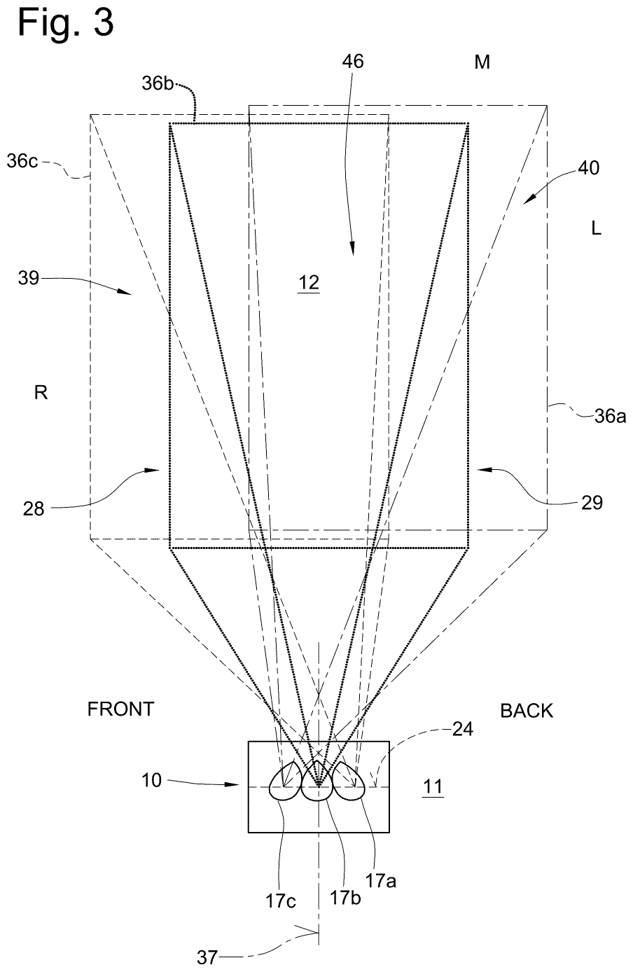

FIG. 3 is a partially sectional, schematic view, approximately according to the viewing arrow III in FIG. 1, of the second building wall to be illuminated, and, schematically in isolation, the reflector bowls of the luminaire, wherein the luminaire comprises three reflector bowls, wherein FIG. 3 illustrates, in a schematic view and by way of example, the three different light field contours of the light distributions on the second building wall, generated from the three reflector bowls as a result of the reflection image,

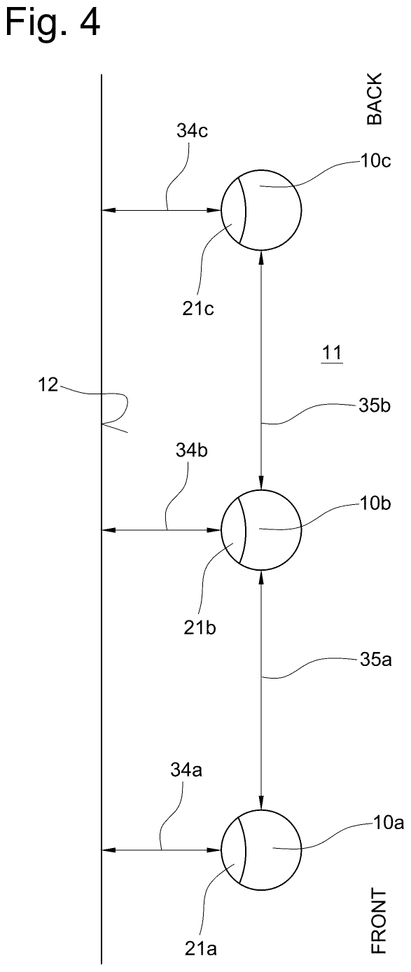

FIG. 4 is a schematic view, approximately according to the viewing arrow IV in FIG. 1, of an embodiment of a system according to the invention, comprising three luminaires according to the invention, for homogeneously illuminating a second building surface, illustrating a first clearance of a luminaire from the wall and for illustrating a second clearance of the luminaire from an adjacent luminaire,

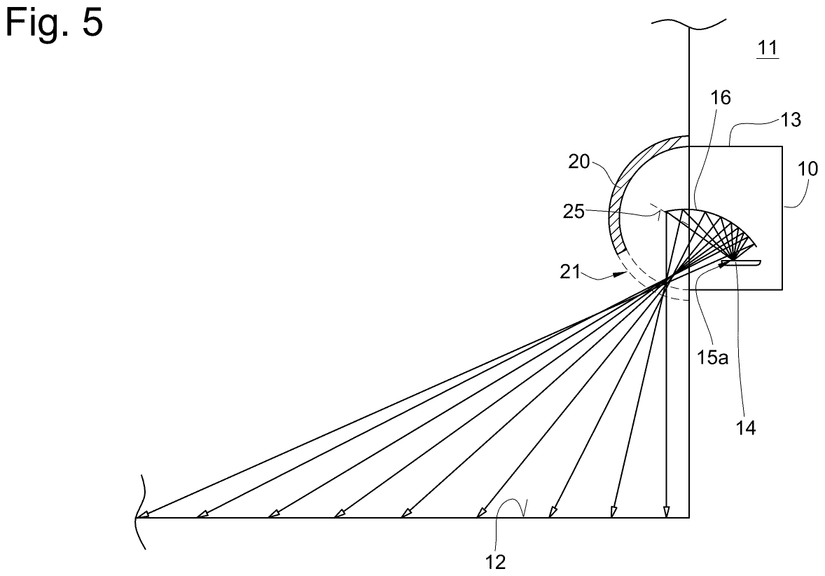

FIG. 5 shows an alternative embodiment of a luminaire according to the invention, in an illustration according to FIG. 1, which is configured as a recessed wall luminaire for illuminating a ground surface,

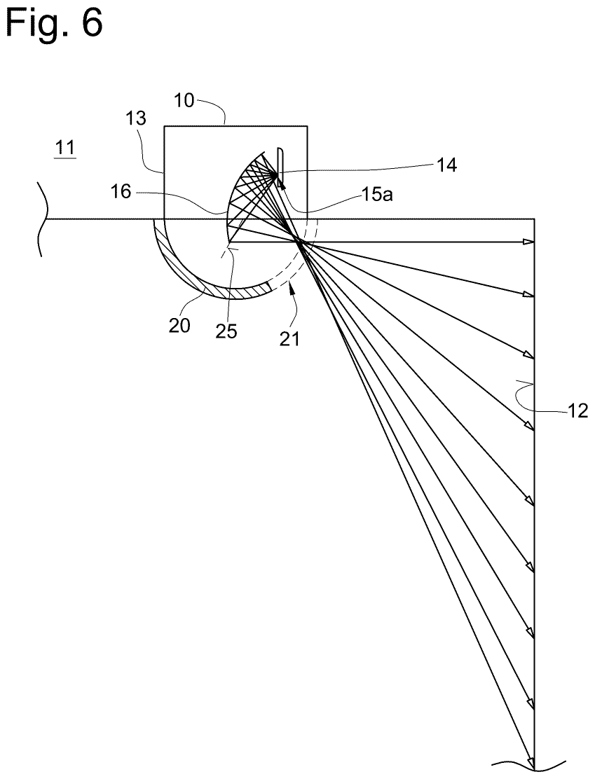

FIG. 6 shows a further embodiment of a luminaire according to the invention, in an illustration according to FIG. 1, which is configured as a recessed ceiling luminaire and serves for illuminating a vertical wall,

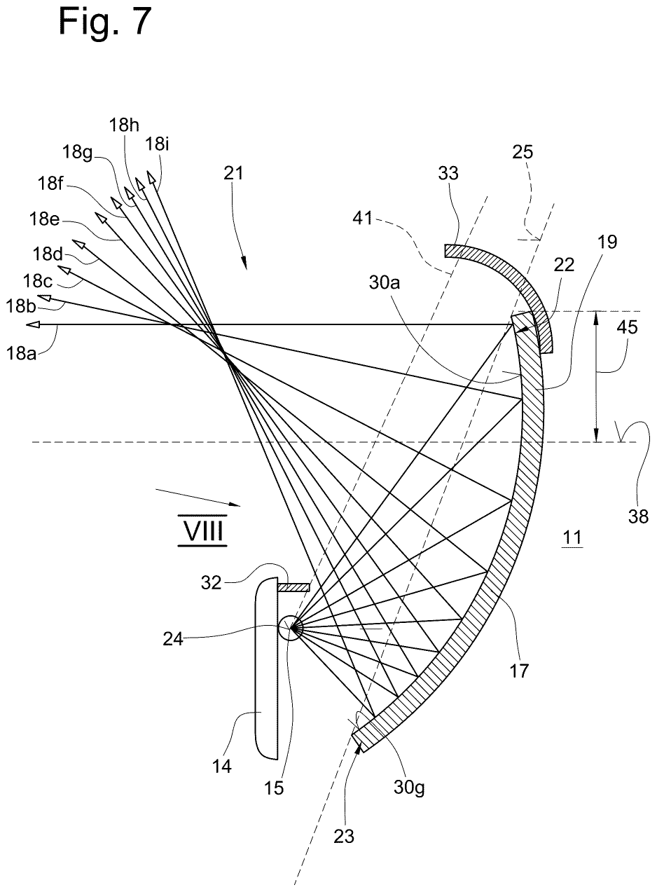

FIG. 7 is a partially sectional, schematic, enlarged view of the internal construction of the luminaire according to FIG. 1, approximately according to the reference circle VII in FIG. 1, illustrating additional details,

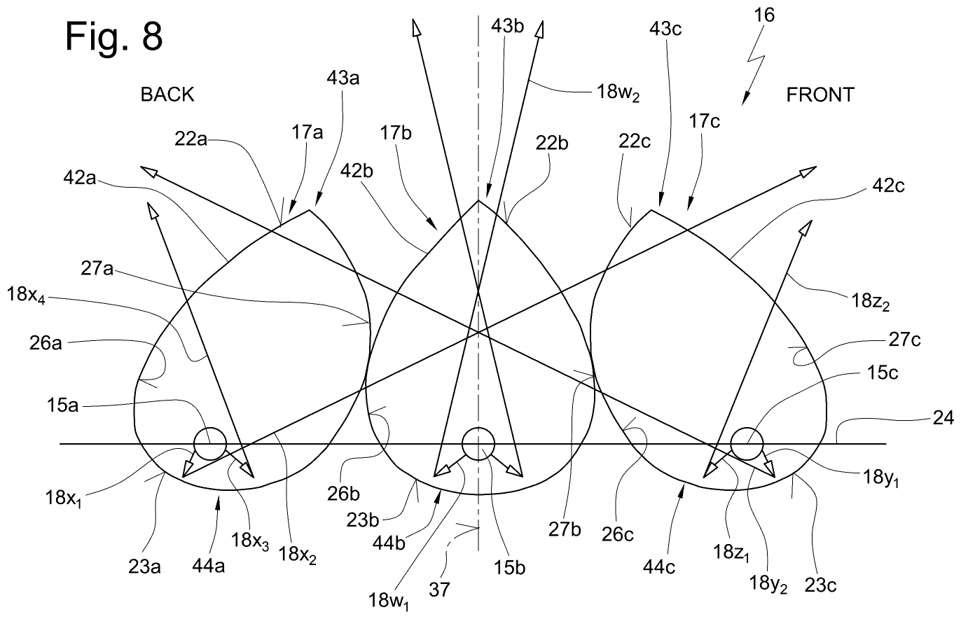

FIG. 8 is a schematic view in isolation, approximately according to the viewing arrow VIII in FIG. 7, of the reflector arrangement of the embodiment of the luminaire of FIG. 1, with three reflector bowls and with three LED clusters, wherein the printed circuit board and the shielding elements have been omitted for the sake of clarity,

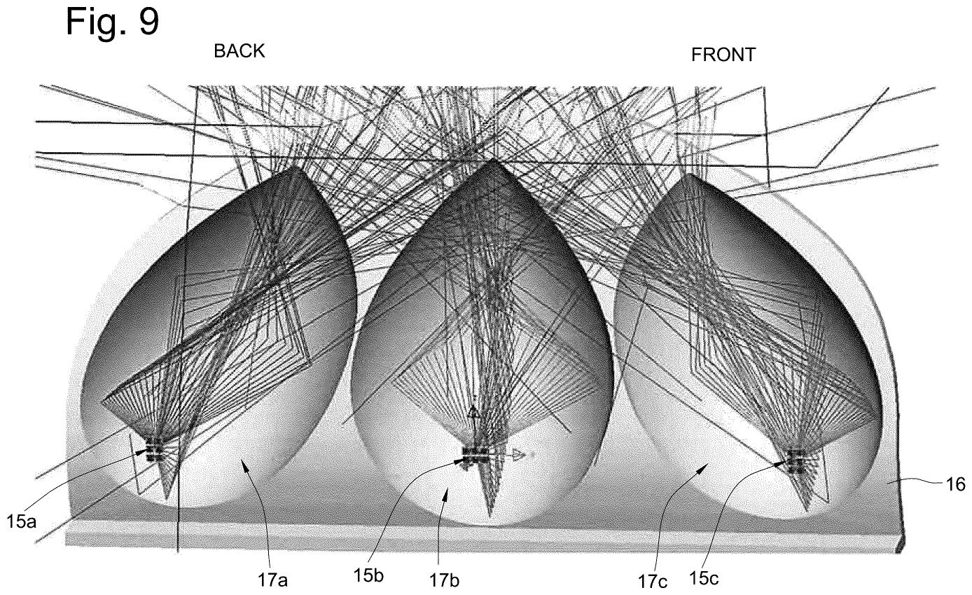

FIG. 9 is a further schematic amended illustration of the embodiment of the reflector arrangement of FIG. 8 with three reflector bowls, similarly to the illustration of FIG. 8, in a grey scale image, for illustrating numerous light beams,

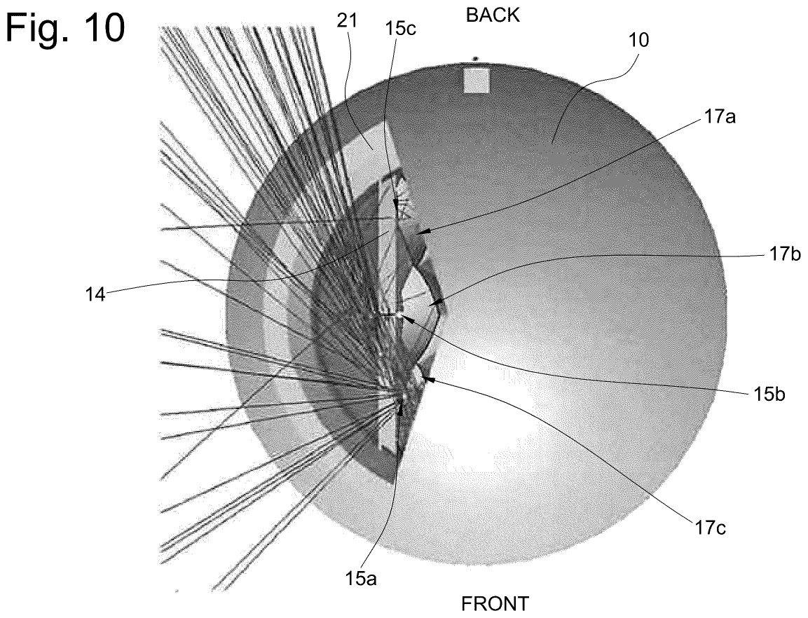

FIG. 10 shows a further embodiment of a luminaire approximately according to the viewing arrow II in FIG. 1, in an illustration according to FIG. 9, wherein the window-like cutout of the embodiment of FIG. 10 differs from the embodiment of FIG. 2,

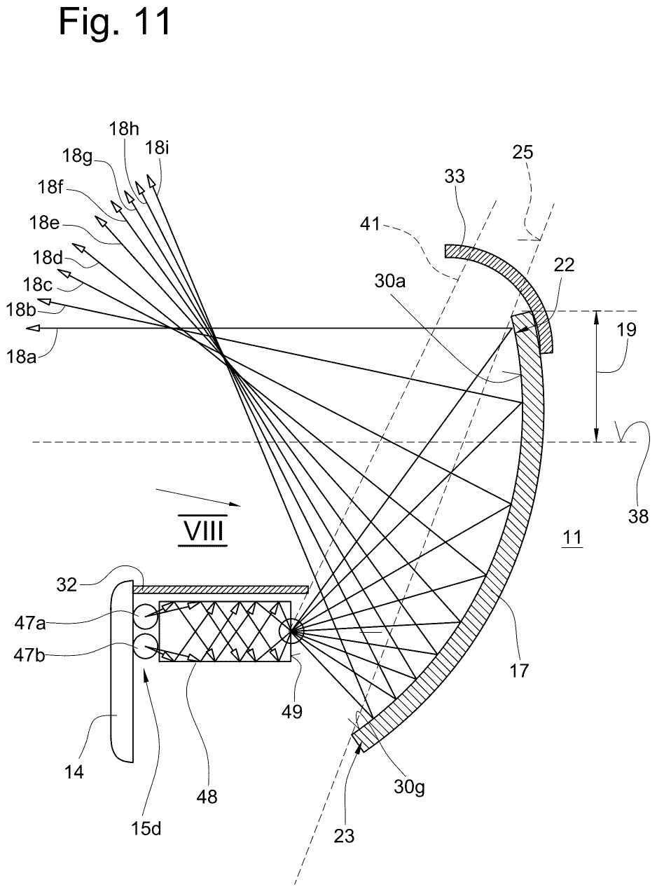

FIG. 11 shows a further embodiment of a luminaire, in an illustration according to FIG. 7, wherein the printed circuit board is arranged offset relative to the position of FIG. 7, such that the clearance of the printed circuit board from the reflector arrangement is increased, wherein the embodiment comprises an amended LED cluster, and wherein a light guide supplies the light, emitted from the two LED clusters, in mixed form to a light emission surface,

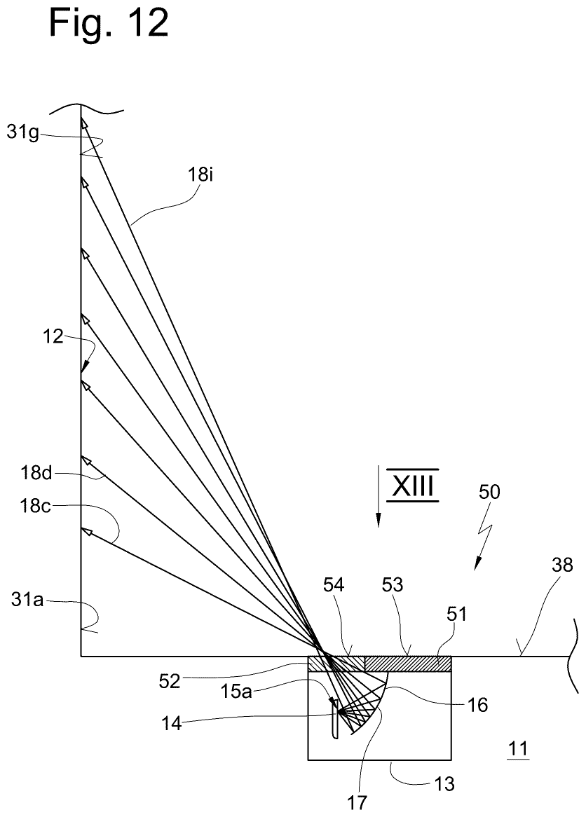

FIG. 12 shows an embodiment of a further luminaire according to the invention, which allows for flush-mounted fitting into the first building wall, and in which the reflector arrangement does not comprise any overhang region, in an illustration analogous to the illustration of FIG. 1,

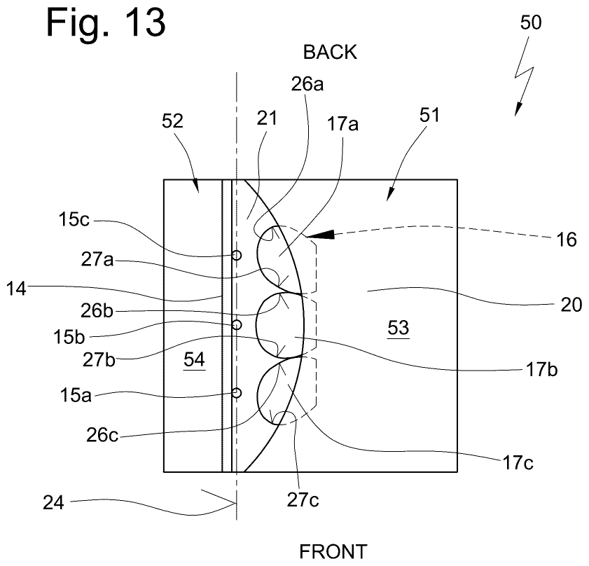

FIG. 13 is an enlarged, partially sectional, schematic view of the embodiment of FIG. 12 in isolation, according to the viewing arrow XIII in FIG. 12, and

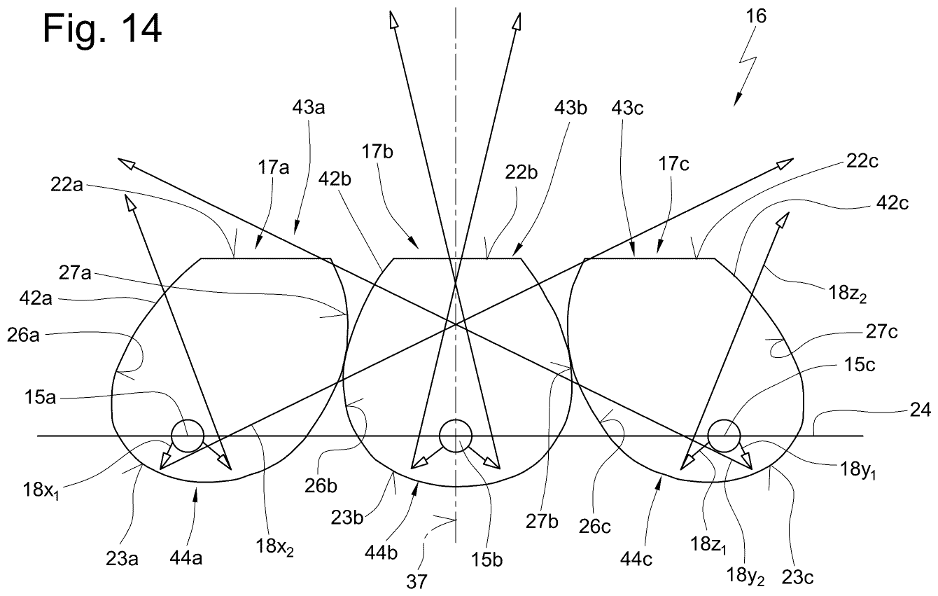

FIG. 14 shows the reflector arrangement of the embodiment of FIGS. 12 and 13 in an illustration according to FIG. 8.

Embodiments of the invention are described by way of example in the following description of the figures, also with reference to the drawings. In this case, for the sake of clarity-also as far as different embodiments are concerned-identical or similar parts or elements or regions are denoted by the same reference signs, sometimes with the addition of lower-case letters or of apostrophes.

Features that are described only with reference to one embodiment can also be provided, within the context of the invention, in any other embodiment of the invention. Embodiments amended in this way—even if they are not shown in the drawings—are also covered by the invention.

All the disclosed features are, per se, essential to the invention. The disclosure content of the associated priority documents (copy of the prior application) and the cited documents and the described devices of the prior art are hereby also incorporated in their entirety into the disclosure of the application, also for the purpose of also incorporating individual or multiple features of these documents into one or more claims of the present application.

The embodiments shown in the drawings denote the luminaire in its entirety by reference sign 10. A first embodiment of a luminaire 10 is shown schematically in FIG. 1. In this embodiment, the luminaire 10 is configured as a recessed luminaire and is recessed into a base wall 11. In this embodiment, the base wall is, in the terminology of the present patent application, the first building wall 11.

The luminaire 10 serves for illuminating a second building wall 12 which, in the embodiment according to FIG. 1, is configured as a vertical building wall 12.

A first particularity of the luminaire 10 according to the invention is that, in contrast to conventional luminaires, it protrudes slightly from the first building wall 11. As a result, a lower region 31a of the second building wall 12 can also be illuminated. Further advantages of the luminaire 10 will be explained later with reference to FIG. 4.

The luminaire 10 according to the invention comprises a housing 13 which is referred to as an installation housing and which is inserted into the first building wall 11. It can be cast there, for example, or inserted into a cavity in the first building wall 11.

A printed circuit board 14, on which a plurality of LED clusters 15a, 15b, 15c are arranged, is a component of the housing 13. In the embodiments of FIG. 1 to 11, in each case three LED clusters 15a, 15b, 15c are provided, which, as is not shown in the figures, each comprise a plurality of, e.g. two, high-power LEDs. For the same of simplicity, for optical considerations an LED cluster 15a, 15b, 15c is in each case considered to be a light point or a punctiform light source.

The luminaire 10 according to the invention comprises a reflector arrangement 16 which is indicated in isolation in FIG. 8 and is shown in FIG. 9. The reflector arrangement 16 is in particularly formed in one piece and comprises three reflector bowls 17a, 17b, 17c. The reflector arrangement 16 can e.g. be provided by a plastics injection-molded part. This can be provided with a highly reflective coating.

The luminaire 10 is, as FIGS. 1 and 2 make clear, covered by a dome-shaped cover 20 which is configured to be curved, in particular spherical or cap-like. The cover 20 protrudes outwards out of the first building wall 11 and is configured to be optically opaque. The cover 20 comprises a transparent cutout 21. This is configured in the manner of a window and allows the light, radiated from the reflector arrangement 16, to pass through.

It will first be illustrated, on the basis of the embodiment of FIG. 8, that the central reflector bowl 17b is configured to be completely symmetrical along a plane of symmetry 37. The reflector arrangement 16 is advantageous configured to be symmetrical as a whole with respect to said central plane 37 in all embodiments of the invention.

All three reflector bowls 17a, 17b, 17c are shaped individually. The reflector bowls 17a and 17c are configured identically, but arranged in mirror-image with respect to the plane of symmetry 37.

The three reflector bowls 17a, 17b, 17c each comprise an edge contour 42a, 42b, 42c which is configured to be substantially leaf-shaped or drop-shaped. With respect to FIG. 8, each of the contours 42a, 42b, 42c is configured to taper, and in each case comprises an apex region 43a, 43b, 43c. Each of the three reflector bowls 17a, 17b, 17c is configured to be bulged and comprises a wider bulge region 44a, 44b, 44c.

The two outer reflector bowls 17a and 17c are, as FIG. 8 makes clear, arranged so as to be inclined with respect to the plane of symmetry 37 and having their upper bowl edges 22a, 22c, which in this patent application are referred to as the outer bowl edges 22a and 22c, moved close to the plane of symmetry 37. The respective inner, lower bowl edge 23a, 23c, which is arranged in each case close to the bulge region 44a, 44b, 44c of each reflector bowl 17a, 17b, 17c, is arranged spaced apart from the plane of symmetry 37.

FIG. 8 illustrates the position of the LED clusters 15a, 15b, 15c in relation to the individual reflector bowls 17a, 17b, 17c. The LED clusters 15a, 15b, 15c are arranged far below the center of the respective reflector bowl 17a, 17b, 17c, approximately in the region of the lower fifth of the height of the respective reflector bowl 17a, 17b, 17c.

According to the embodiment of FIG. 7, the outer, upper bowl edge 22 of the reflector bowl 17 can be connected to one another by the inner, lower bowl edge 23 of the reflector bowl 17, by an imaginary straight line 25.

The respective LED cluster 15 is, as follows from FIG. 7, arranged closer to the inner bowl edge 23 than to the outer bowl edge 22.

This provision applies for each of the plurality of reflector bowls 17a, 17b, 17c. This is also shown e.g. by FIG. 8.

FIG. 8 furthermore shows that the three LED clusters 15a, 15b, 15c are arranged along a straight line 24.

Each LED cluster 15a, 15b, 15c radiates light exclusively or largely into the associated reflector bowl 17a, 17b, 17c. At the same time, each of the reflector bowls 17a, 17b, 17c largely or exclusively receives light only from one of the LED clusters 15a, 15b, 15c.

FIG. 7 makes it clear that the LED cluster 15 arranged on a printed circuit board 14 radiates light into the reflector bowl 17.

The light beams, indicated by way of example, are denoted by the reference signs 18a, 18b, 18c, 18d, etc.

In the present case, a particular feature is that those light beams emitted from an LED cluster 15 that are reflected at a portion 30a of the reflector bowl 17a which is arranged close to the outer bowl edge 22, and which in the present case are denoted by reference sign 18a, strike those portions 31a (FIG. 1) of the second building wall 12 to be illuminated which are arranged directly adjacently to the luminaire 10.

Thus, the light components that are reflected on the reflector bowl 17 at the protruding portion 19, i.e. close to the outer bowl edge 22, illuminate regions 31a of the second building wall 12 that are arranged close to the luminaire 10 or that are simultaneously also arranged close to the first building wall 11.

Those light components, see e.g. the light beam 18g, which are emitted from the LED cluster 15 and which strike portions 30g of the reflector bowl 17 that are arranged close to the inner bowl edge 23, illuminate regions 31g (FIG. 1) of the second building wall 12 that are arranged remotely from the luminaire 10 and thus remotely from the first building surface 10.

FIG. 7 illustrates the following:

The further a region 30a, 30g of the reflector bowl, that a light beam 18a, 18g strikes, is spaced from the inner, lower bowl edge 23 of the reflector bowl, the closer the wall portion, to be illuminated with this light beam 18a, 18g, of the wall to be illuminated is arranged to the luminaire 10.

The luminaire 10 according to the invention comprises a reflector arrangement 16 which comprises a protruding portion 19. The reflector arrangement 16 protrudes beyond the outside 38 of the first building wall by the height 45 of the protruding portion 19 (cf. FIG. 7).

Only on account of said overhang region 19 can, as FIG. 1 illustrates, deep regions 31a of the building wall 12 to be illuminated also be illuminated at all.

Thus, the luminaire 10 according to the invention makes it possible to uniformly illuminate the entire second building wall 12, from the very top to the very bottom.

FIG. 3 makes it clear that the second building wall 12 to be illuminated can be divided into a front, with respect to FIG. 3 left-hand, wall region 28, a rear, with respect to FIG. 3 right-hand, wall region 29, and a central wall region 46. In this case the terms front wall region 28 and rear wall region 29 relate to the direction of the straight line 24 that interconnects the LED clusters 15a, 15b, 15c.

The terms front and rear reflector bowl, front and rear wall portions, front and rear bowl edges etc. relate to the viewing direction of a viewer of the embodiment of FIG. 1. Front elements are, based on the viewing direction of FIG. 1, those elements that are closer to the viewer than the corresponding rear elements.

The light distributions generated by the individual reflector bowls 17a, 17b, 17c have different light field contours 36a, 36b, 36c. These are indicated on the building wall 12 to be illuminated, in FIG. 3, wherein the light distributions associated with the different light field contours 36a, 36b, 36c of course overlap and add to one another in total.

It is noted that in FIG. 3 the three light field contours 36a, 36b, 36c have slightly different heights. However, this illustration was selected only for simplified illustration. In fact, the plurality of light distributions should be of the same height, on the building wall 12 to be illuminated.

It is important that the central reflector bowl 17b, based on FIG. 3, illuminates a central region 46 of the building surface 12, and in the process generates approximately a light field contour 36b, which is denoted by reference sign 36b in FIG. 3.

The far left-hand, front region of the wall 12, based on FIG. 3, approximately the left-hand sixth 39 of the wall 12, and the far right-hand, rear sixth 40 of the wall 12, based on FIG. 3, is, however, for example not covered by the light distribution of the central reflector bowl element 17b.

In contrast, the, based on FIG. 3 left-hand, front reflector bowl element 17c, shown in rear view in FIG. 3, generates a light distribution having a light field contour 36a that extends approximately along a right-hand, rear region of the wall 12 that includes ⅔ of the width of the wall 12. The light field contour 36a thus extends in particular over the central region 46 and the right-hand, rear region 29 of the building wall 12.

The left-hand third, i.e. the front wall portion 28 of the building wall 12, is, in contrast, not covered by the light distribution generated by the left-hand reflector bowl element 17c.

The right-hand, rear reflector bowl element 17a generates for example a light field contour 36c, such that, based on the building wall 12, the right-hand or rear third is not covered by the reflector bowl element 17a. The right-hand reflector bowl element 17a thus illuminates the front, left-hand wall portion 28 and the central wall portion 46 of the building wall 12, but not the right-hand or rear wall portion 29.

Thus, the luminaire according to the invention provides a first direction change of the light components. Based on the reflector bowl 17c arranged to the left of the plane of symmetry 37 in FIG. 3, i.e. the front reflector bowl 17c, this serves primarily for illuminating rear wall connections 29 of the building wall. The reflector bowl element 17a arranged to the right of the plane of symmetry 37 based on FIG. 3, i.e. the rear reflector bowl element 17a, serves primarily for illuminating front wall portions 28 of the building wall 12. Thus, a first direction change takes place.

Furthermore, however, a second direction change of the light components takes place, which is to be explained on the basis of FIG. 8. FIG. 8 shows, which should be noted at this point, in contrast to FIG. 3, the reflector arrangement 16 with its three bowl elements 17a, 17b, 17c in a front view, i.e. in mirror-image based on FIG. 3. FIG. 8 illustrates-by way of example for a plurality of further light beams-on the left-hand, rear reflector bowl element 17a, a light beam 18x₁ which emerges from the LED cluster 15 and which is reflected as light beam 18x₂, which intersects the plane of symmetry 37.

Similarly, FIG. 8 illustrates, for the front reflector bowl element 17c, by way of example, a light beam 18y₁ which, after reflection at the reflector bowl 17c, becomes a light beam 18y₂ which also intersects the plane of symmetry 37.

Other light beams, such as the light beam 18z₁, become, after reflection, light beams 18z₂ which do not intersect the plane of symmetry 37.

The indicated course of the light beams of FIG. 8 makes clear that all the light beams, or in any case the vast majority of the light beams, which, proceeding from an LED cluster 15a, 15b, 15c, before their reflection at the inner surface of the associated reflector bowl 17a, 17b, 17c, have a direction component towards the plane of symmetry 37, after competed reflection have a course directed away from the plane of symmetry 37. Those light beams which, before reflection at the inner surface of the associated reflector bowl 17a, 17b, 17c, have a direction component which leads away from the plane of symmetry 37, are directed, after reflection, towards the plane of symmetry 37 and intersect this.

In this case, FIG. 8 illustrates the direction change of the light beams with respect to the plane of symmetry 37.

In other words, FIG. 8 makes it clear that light components which, proceeding from an LED cluster, e.g. the LED cluster 15a are directed in a direction towards a rear bowl edge 26 of the reflector bowl 17a, or at least comprise one direction component thereto, primarily serve to illuminate front wall portions 28 of the wall 12, as is illustrated e.g. by the arrows 18x₁, 18x₂, but analogously also by the arrow 18z₁, 18z₂ and the arrow 18w₁, 18w₂ in FIG. 8.

Those light components which, however, proceeding from an LED cluster 15a (or another LED cluster), are emitted towards a front bowl edge 27a of the reflector bowl 17a (cf. e.g. arrow 18x₃), will, after reflection, illuminate rear wall regions 29 of the building wall as arrow 18x₄.

The consideration of said light beam course of the light beams 18x₁, 18x₂, 18x₃, 18x₄ of the reflector bowl 17a of course applies correspondingly with respect to the corresponding front bowl edges 27b, 27c and the rear bowl edges 26b, 26c for the reflector bowls 17b, 17c, with reference to FIG. 8. Thus, a lighting change in a second respect is provided.

In the same way, an, even if slightly more complicated, third direction change of the light components in the vertical direction also takes place, as illustrated in FIG. 7. In this case: The further downwards from the LED cluster 15 according to FIG. 7 light beams are emitted towards regions 30g close to the inner bowl edge 23, the higher the reflected light beams (e.g. light beam 18h in FIG. 7) strike corresponding regions of the second building wall 12 to be illuminated.

There is thus a direction change of light beams in multiple respects in the luminaire 10 according to the invention.

It is clear from FIG. 4 that, when the luminaire 10a, 10b, 10c according to the invention is used, very large clearances 35a, 35b, 35c between two luminaires in each case, e.g. between the luminaires 10a, 10b, can be achieved in the case of only very small clearances 34a, 34b, 34c from a building wall 12 to be illuminated. Thus, a homogeneous illumination of high and wide building surfaces 12 can be achieved with an only small number of luminaires 10a, 10b, 10c, with a small wall clearance 34.

FIG. 5 illustrates an alternative fitting situation, in which the luminaire 10 according to the invention is arranged on a building wall 11, e.g. in the lower region, e.g. at a height of only 50 cm above the ground surface 12, and serves for illuminating the ground surface 12.

FIG. 6 illustrates a further embodiment of a luminaire 10 according to the invention, which is configured as a recessed ceiling luminaire 10 and which is fitted into a ceiling of a building space. Here, the side wall 12 is illuminated downwards from the ceiling.

The patent application uses the terms inner or lower bowl edge, as well as outer and upper bowl edge. This use of the terms top and bottom relates to the consideration of the embodiment of FIG. 1 and presupposes that the luminaire 10 according to the invention is configured as a ground recessed luminaire, as shown in FIG. 1. When the luminaire 10 according to the invention is used as a recessed ceiling luminaire, the terms top and bottom must be understood geometrically inverted.

The figures show the luminaire 10 with respect to its structural design only as a schematic sketch. In the embodiments the printed circuit board 14 is, although not shown, arranged fixedly relative to the housing 13, e.g. firmly screwed thereto. The reflector arrangement 16 is also, which is not shown in the figures, arranged fixedly relative to the housing 13, fixed either directly or indirectly to the housing 13 of the luminaire.

The spacer elements 32, 33 are also arranged fixedly, directly or relative to the housing 13 of the luminaire. They can e.g. be mechanically connected to the printed circuit board 14 and/or to the reflector arrangement 16.

FIG. 11 shows a further embodiment of a luminaire 10 according to the invention, in an illustration comparable to FIG. 7.

The luminaire 10 of FIG. 11 comprises a plurality of LED clusters 15d, which are each provided from two different LEDs 47a, 47b. The two LEDs 47a, 47b can e.g. be two white light-emitting LEDs of different color temperature, or differently colored LEDs, e.g. one red or one green LED.

It is also possible for more than two LEDs to be combined to an LED cluster 15d. The LED clusters 15d are in turn arranged on a printed circuit board 14.

A light guide 48, e.g. a transparent plastics cylinder, in the manner of an optical fiber, is also arranged on the printed circuit board 14. The two LEDs 47a, 47b radiate their light into this. On account of total reflection, on the one hand light guidance occurs, within the light guide 48, from the light entry surfaces to a light emission surface 49. On the other hand, the light guide 48 also ensures color mixing of the light. The light emerging from the light emission surface 49 is therefore well mixed in terms of color. The light emission surface 49 emits the light analogously to the illustration of the embodiment of FIG. 7, and radiates the mixed light into the reflector bowl 17.

In turn, the embodiment of FIG. 11 comprises a plurality of LED clusters 15d arranged on the printed circuit board 14, wherein FIG. 11 only shows one of these clusters, and a number of reflector bowls 17a, 17b, 17c that corresponds to the number of the LED clusters 15d.

The luminaire of the embodiment of FIG. 11 allows for particularly good color mixing of the light of the different LEDs 47a, 47b with different spectra on the second building wall 12 to be illuminated, and also in the case of different white light LEDs, which allow for white light of different color temperatures, the adjustable desired color temperature can be achieved. A good mixing in terms of color can also be achieved in the case of differently colored LEDs, such as RG and B LEDs (red-green-blue). On the one hand the light guide 48 contributes to this, and on the other hand the number of LED clusters 15a, 15, 15c to a corresponding number of reflector bowls 17a, 17b, 17c, and finally the above-explained cross-over reflection in multiple respects. In this case, an overlapping of a plurality of light distributions on the building wall 12 occurs, such that different color locations of the light distribution can no longer be resolved there for the viewer.

A further embodiment of a luminaire 50 according to the invention will now be explained with reference to FIG. 12 to 14. This luminaire is denoted in its entirety, in FIG. 12 to 14, with the reference sign 50. The remaining parts and elements are shown using the same reference signs as in the embodiments of FIG. 1 to 11.

The luminaire 50 of FIG. 12 is provided for flush, in particular flush-mounted, fitting into the first building wall 11. The luminaire 50 in turn comprises a luminaire housing 13 and a printed circuit board 14, on which a plurality of LED clusters 15a, 15b, 15c are arranged, and a reflector arrangement 16 comprising a number of reflector bowls 17a, 17b, 17c that corresponds to the number of LED clusters 15a, 15b, 15c.

In contrast to the embodiment of FIG. 1 to 11, here the reflector arrangement 16 does not protrude out of the building wall 11. The luminaire 50 is arranged having its upper side 53, 54 flush with the upper side 38 of the first building wall 11.

The reflector arrangement 16 of the embodiment of FIG. 12 to 14 in principle corresponds almost identically to the reflector arrangement 16 of the embodiment of FIG. 1 to 11, with the difference that the apex regions 43a, 43b, 43c of the reflector bowls 17a, 17b, 17c are, as it were, cut off or capped.

FIG. 14 makes clear that the portion of the reflector arrangement 16 referred to in the embodiments of FIG. 1 to 11 as the protruding portion 19 is missing. Said protruding portion protruded from the first building wall 11, in the embodiment described above.

The fact that this protruding portion 19 is missing in the embodiment of FIG. 12 to makes a flush arrangement of the luminaire 50 possible in the first place.

In the simplest case, reflector arrangements 16 can be used, as in the embodiment of FIG. 1 to 11, with changed apex regions 22a, 22b, 22c according to FIG. 14.

FIG. 14 shows that these apex regions 22a, 22b, 22c are flattened.

FIG. 12 makes it clear that the reflector arrangement 16 of the luminaire 50 is arranged completely inside the building wall 11. The upper side of the luminaire 50 comprises, according to FIG. 12 to 14, a cover portion 51 having an upper side 53 which can be configured to be optically opaque.

Furthermore, the luminaire 50 comprises a cover portion 52 in which a cutout or a window is arranged. The portion 52 can in particular be configured as a transparent pane and allow the light to pass through.

The optically opaque portion 51 protrudes, according to FIG. 12, from the right-hand edge of the housing 13 to the left towards the building wall 12, until close to the light beams which illuminate the lowest region on the second building wall 12.

FIG. 12 makes it clear, with its light beam course, that the very lowest portion 31a, according to FIG. 1, of the building surface 12 to be illuminated cannot also be illuminated by the luminaire 50 of FIG. 12 to 14, in view of the missing overhang region 19.

At the same time, however, the luminaire 50 according to the embodiments of FIG. 12 to 14 allows for homogeneous illumination of the building wall 12, along a very wide region. This takes into account the fact that, in certain fitting situations, the lower portions 31 of the second building wall 12 that are close to the luminaire 50 do not essentially also have to be illuminated.

Advantageously, the reflector arrangement 16 of the embodiment of FIG. 12 to 14 has a cross-over characteristic of the light beams, as is shown in FIG. 14. This direction change, described above, of the light beams, allows for an overlapping of different light distributions on the building wall to be illuminated in multiple respects, as in the embodiment described above, and thus homogenization and a particularly wide light distribution.

In this embodiment, too, the luminaire 50 comprises a plurality of LED clusters 15a, 15b, 15c, which are arranged along a straight line 24 that extends in parallel with the building wall 12 to be illuminated.

Otherwise, for the understanding and the description the embodiment of FIG. 12 to 14 the description of the embodiments of FIG. 1 to 11 applies analogously.

Finally, it is noted that in the same way a homogeneous color mixing can also be achieved with luminaires 50 according to the embodiments of FIG. 12-14, if the LED clusters 15a, 15b, 15c comprise LEDs 47a, 47b that emit different light spectra, i.e. for example different white light of different color temperature, or different colored light e.g. red, green or blue light.

1-40. (canceled)

41. A luminaire to be mounted into a first building wall and for illuminating a second building wall arranged adjacently to the first building wall, comprising: a housing; a printed circuit board on which a plurality of LED clusters are arranged; and a reflector arrangement comprising a number of reflector bowls that corresponds to a number of the LED clusters, wherein the housing and the reflector arrangement are recessed into the first building wall, and wherein the reflector arrangement protrudes outwards from the first building wall with a protruding portion, wherein the luminaire is covered by a dome-shaped cover that has a cutout which can be passed through by light and which faces the second building wall in an assembly state of the luminaire and which allows passing of parts of the light, emitted from the LED clusters and reflected at the reflector bowls, including parts of the light reflected at the protruding portion to the second building wall.

42. The luminaire according to claim 41, wherein the reflector bowls each comprise an outer bowl edge which protrudes from the first building wall, and an inner bowl edge which protrudes into the first building wall.

43. The luminaire according to claim 42, wherein a connection line between an outer bowl edge and an inner bowl edge forms a straight line which is arranged inclined relative to the second building wall.

44. The luminaire according to claim 42, wherein the LED clusters are arranged closer to the inner bowl edge than to the outer bowl edge.

45. The luminaire according to claim 42, wherein the outer bowl edge of a reflector bowl is spaced approximately 1.5 times to 10 times as far from the associated LED cluster compared with the inner bowl edge.

46. The luminaire according to claim 41, wherein the plurality of LED clusters are arranged along a straight line that extends in parallel with the second building wall.

47. The luminaire according to claim 46, wherein each reflector bowl, based on the direction of the straight line, has a front bowl edge and a rear bowl edge, and the second building wall, based on the direction of the straight line, has a front wall region and a rear wall region, wherein the light components that are cast from an LED cluster onto portions of the associated reflector bowl which are arranged close to the front bowl edge are deflected towards regions of the second building wall that are adjacent to the rear wall region, and wherein the light components that are cast from an LED cluster onto portions of the associated reflector bowl that are arranged close to the rear bowl edge are deflected towards regions of the second building wall that are adjacent to the front wall region.

48. The luminaire according to claim 41, wherein only those light components, emitted by the LED clusters, that have undergone a reflection at a reflector bowl of the reflector arrangement strike the second building surface.

49. The luminaire according to claim 41, wherein the luminaire comprises shielding elements which prevent an emission of unreflected light components.

50. The luminaire according to claim 41, wherein each LED cluster, is associated with a reflector bowl.

51. The luminaire according to claim 41, wherein each reflector bowl receives light from just one LED cluster.

52. The luminaire according to claim 42, wherein the light components that are cast from an LED cluster onto portions of the associated reflector bowl that are arranged close to the outer bowl edge are deflected towards regions of the second building wall that are adjacent to the first building wall, and the light components that are cast from an LED cluster onto portions of the associated reflector bowl that are arranged close to the inner bowl edge are deflected towards regions of the second building wall that are arranged remotely from the first building wall.

53. The luminaire according to claim 41, wherein each LED cluster comprises one LED or a plurality of LEDs that are arranged adjacently to one another or directly adjacently.

54. The luminaire according to claim 41, wherein the luminaire comprises three LED clusters and three reflector bowls.

55. The luminaire according to claim 41, wherein the luminaire is configured as a ground recessed luminaire and for illuminating a vertical or substantially vertical building wall.

56. The luminaire according to claim 41, wherein the reflector bowls of the reflector arrangement are configured symmetrically with respect to a central longitudinal plane of the reflector arrangement.

57. The luminaire according to claim 41, wherein at least one LED cluster is composed of at least two different LEDs which emit light of different spectra.

58. The luminaire according to claim 57, wherein the two LEDs radiate light into a light guide which is fixed relative to the printed circuit board and which guides the light, while allowing for light mixing, to a light emission surface, from which the mixed light is cast onto the associated reflector bowl.

59. A system for homogeneous wall flooding, comprising a plurality of luminaires according to claim 41, wherein the plurality of luminaires are arranged along a straight line, and wherein the plurality of luminaires are configured for joint illumination of the second building wall.

60. The system according to claim 59, wherein the luminaires each have a first clearance from the second building wall and a second clearance from an adjacent luminaire, wherein a ratio of the first clearance to the second clearance is between 1:5 and 1:8.

61. The system according to claim 60, wherein the first clearance is less than 100 cm or less than 60 cm.

62. A luminaire for flush-mounted fitting into a first building wall and for illuminating a second building wall arranged adjacently to the first building wall, comprising: a housing; a printed circuit board on which a plurality of LED clusters are arranged; and a reflector arrangement comprising a number of reflector bowls that correspond to the number of the LED clusters, wherein the housing is recessed, with the reflector arrangement, into the first building wall, wherein the luminaire is covered by a cover which comprises at least one transparent cutout which allows light components emitted from the LED clusters and reflected at the reflector bowls to pass through to the second building wall.

63. The luminaire according to claim 62, wherein the reflector bowls each comprise an outer bowl edge arranged adjacently to the upper side of the first building wall, and an inner bowl edge which protrudes into the first building wall.

64. The luminaire according to claim 63, wherein a connection line between an outer bowl edge and an inner bowl edge forms a straight line which is arranged inclined relative to the second building wall.

65. The luminaire according to claim 63, wherein the LED clusters are arranged closer to the inner bowl edge than to the outer bowl edge.

66. The luminaire according to claim 63, wherein the outer dish edge of a reflector bowl is spaced approximately 1.5 times to 10 times as far from the associated LED cluster compared with the inner bowl edge.

67. The luminaire according to claim 62, wherein the plurality of LED clusters are arranged along a straight line that extends in parallel with the second building wall.

68. The luminaire according to claim 67, wherein each reflector bowl, based on the direction of the straight line, has a front bowl edge and a rear bowl edge, and the second building wall, based on the direction of the straight line, has a front wall region and a rear wall region, wherein the light components that are cast from an LED cluster onto portions of the associated reflector bowl which are arranged close to the front bowl edge are deflected towards regions of the second building wall that are adjacent to the rear wall region, and the light components that are cast from an LED cluster onto portions of the associated reflector bowl that are arranged close to the rear bowl edge are deflected towards regions of the second building wall that are adjacent to the front wall region.

69. The luminaire according to claim 62, wherein only those light components, emitted by the LED clusters, that have undergone a reflection at a reflector bowl of the reflector arrangement strike the second building surface.

70. The luminaire according to claim 62, wherein the luminaire comprises shielding elements which prevent an emission of unreflected light components.

71. The luminaire according to claim 62, wherein each LED cluster is associated with a reflector bowl.

72. The luminaire according to claim 62, wherein each reflector bowl receives light from just one LED cluster.

73. The luminaire according to claim 63, wherein the light components that are cast from an LED cluster onto portions of the associated reflector bowl that are arranged close to the outer bowl edge are deflected towards regions of the second building wall that are adjacent to the first building wall, and the light components that are cast from an LED cluster onto portions of the associated reflector bowl that are arranged close to the inner bowl edge are deflected towards regions of the second building wall that are arranged remotely from the first building wall.

74. The luminaire according to claim 62, wherein each LED cluster comprises one LED or a plurality of LEDs that are arranged adjacently to one another or directly adjacently.

75. The luminaire according to claim 62, wherein the luminaire comprises three LED clusters and three reflector bowls.

76. The luminaire according to claim 62, wherein the luminaire is configured as a ground recessed luminaire and for illuminating a vertical or substantially vertical building wall.

77. The luminaire according to claim 62, wherein the reflector bowls of the reflector arrangement are configured symmetrically with respect to a central longitudinal plane of the reflector arrangement.

78. A system comprising a plurality of luminaires according to claim 62, wherein the plurality of luminaires are arranged along a straight line, and wherein the plurality of luminaires are configured for joint illumination of the second building wall.

79. The system according to claim 78, wherein the luminaires each have a first clearance from the second building wall and a second clearance from an adjacent luminaire, wherein the ratio of the first clearance to the second clearance is between 1:5 and 1:8.

80. The system according to claim 79, wherein the first clearance is less than 100 cm or less than 60 cm.

81. The system according to claim 45, wherein the outer bowl edge of each reflector bowl is spaced approximately 1.5 times to 10 times as far from the associated LED cluster compared with the inner bowl edge.

82. The system according to claim 66, wherein the outer bowl edge of each reflector bowl is spaced approximately 1.5 times to 10 times as far from the associated LED cluster compared with the inner bowl edge.
